(19) United States
(12) Patent Application Publication
(10) Pub. No.: US 2011/0217894 A1
(43) Pub. Date: Sep. 8, 2011

(54) TWO-SIDED HYDROPHILIC/HYDROPHOBIC NONWOVEN AND METHOD OF MANUFACTURING THEREOF

(75) Inventors: W. Andrew Coslett, Drums, PA (US); Lynda A. Kelly, Needham, MA (US); John C. Parsons, Mountain Top, PA (US)

(73) Assignee: FIRST QUALITY NONWOVENS, INC., Great Neck, NY (US)

(21) Appl. No.: 12/874,007

(22) Filed: Sep. 1, 2010

Related U.S. Application Data
(60) Provisional application No. 61/239,560, filed on Sep. 3, 2009.

(51) Int. Cl. B32B 5/26; B29B 9/06; B29C 43/24

(52) U.S. Cl. 442/382; 264/175

(57) ABSTRACT

A nonwoven fabric comprises: a first layer comprising hydrophilic spunbond fibers including a hydrophilic melt additive, the first layer forming at least one exposed outer surface of the nonwoven fabric; a second layer comprising hydrophobic spunbond fibers, the second layer forming an opposite exposed outer surface of the nonwoven fabric; and a third layer comprising meltblown fibers interposed between the first and second layers; wherein the nonwoven fabric has an absorptive capacity of at least 100%.

### FIELD OF THE INVENTION

The present invention relates to nonwoven fabrics. More specifically, the present invention relates to a two-sided hydrophobic/hydrophilic nonwoven composite fabric, and a process of manufacturing thereof.

### BACKGROUND OF THE INVENTION

Some protective medical and industrial apparel, such as scrub suits, surgical gowns, and facemasks, are typically made from a nonwoven fabric that has good absorption and wicking properties on a surface facing the wearer, but which retains strong barrier properties on the outer facing surface. Conventionally, a two layer material is used in which a hydrophilic spunlaced nonwoven is combined with a hydrophobic spunbond nonwoven. The hydrophilic spunlaced nonwoven acts as the perspiration wicking layer, and the hydrophobic spunbond nonwoven acts as the outer barrier layer.

It is desired to produce a two-sided SMS (spunbond-meltblown-spunbond) nonwoven fabric to provide a simpler structure which will provide similar functionality and reduce production costs. Conventional SMS nonwoven fabrics are not suitable for this application, as an SMS nonwoven is typically comprised of a thermoplastic polymer, such as polypropylene, which causes the nonwoven to be naturally hydrophobic. As a result, the SMS nonwoven possesses sufficient barrier properties, but has negligible absorption properties.

There are known topical hydrophilic treatments for making a nonwoven fabric wettable to increase absorption, such as a surfactant treatment. However, topically applied surfactant treatments migrate to other layers in the SMS structure, making the entire structure wettable and unsuitable for this application. Moreover, topical treatments are not durable and lose their effectiveness over time

Accordingly, there is a need for a durable, two-sided SMS nonwoven with improved wettability and fluid wicking on one surface while maintaining a repellant barrier on the outside.

### SUMMARY OF THE INVENTION

According to one embodiment, a nonwoven fabric comprises: a first layer comprising hydrophilic spunbond fibers including a hydrophilic melt additive, the first layer forming at least one exposed outer surface of the nonwoven fabric; a second layer comprising hydrophobic spunbond fibers, the second layer forming an opposite exposed outer surface of the nonwoven fabric; and a third layer comprising meltblown fibers interposed between the first and second layers; wherein the nonwoven fabric has an absorptive capacity of at least 100%.

In at least one embodiment, the nonwoven fabric has an absorbent capacity of about 300 to 500%.

In at least one embodiment, the nonwoven fabric has a hydrostatic head of at least 30 mbar when challenged from the hydrophobic outer surface.

In at least one embodiment, the nonwoven fabric has a hydrostatic head of at least 30 to 65 mbar when challenged from the hydrophobic outer surface.

In at least one embodiment, the nonwoven fabric has an air permeability of at least about 30 cfm.

In at least one embodiment, nonwoven fabric has a spunbond content of about 50 to 90% and meltblown content of about 10 to 50%.

In at least one embodiment, nonwoven fabric has a spunbond content of about 72 to 78% and a meltblown content of about 22 to 28%.

In at least one embodiment, the hydrophilic melt additive is included at a percent addition of about 2.5 to 6%.

In at least one embodiment, the hydrophilic melt additive is included at a percent addition of about 4%

In at least one embodiment, the hydrophilic melt additive is non-migratory to the other layers of the fabric.

In at least one embodiment, the hydrophilic spunbond fibers are comprised of at least one of polypropylene, polyethylene, polyester, polyamide, and polylactic acid.

In at least one embodiment, the second and third layers are comprised of at least one of polypropylene, polyethylene, polyester, polyamide, and polylactic acid.

In at least one embodiment, the basis weight of the nonwoven fabric is between about 10 to 100 gsm.

In at least one embodiment, the basis weight of the nonwoven fabric is between about 34 to 68 gsm.

In at least one embodiment, the basis weight of the nonwoven fabric is between about 40 to 44 gsm.

According to one embodiment, an absorbent article comprises: a nonwoven fabric comprising a first layer comprising hydrophilic spunbond fibers including a hydrophilic melt additive, the first layer forming at least one exposed outer surface of the nonwoven fabric; a second layer comprising hydrophobic spunbond fibers, the second layer forming an opposite exposed outer surface of the nonwoven fabric; and a third layer comprising meltblown fibers interposed between the first and second layers; wherein the nonwoven fabric has an absorptive capacity of at least 100%.

According to one embodiment, medical protective apparel comprises: a nonwoven fabric comprising a first layer comprising hydrophilic spunbond fibers including a hydrophilic melt additive, the first layer forming at least one exposed outer surface of the nonwoven fabric; a second layer comprising hydrophobic spunbond fibers, the second layer forming an opposite exposed outer surface of the nonwoven fabric; and a third layer comprising meltblown fibers interposed between the first and second layers; wherein the nonwoven fabric has an absorptive capacity of at least 100%.

According to one embodiment, a process of manufacturing a nonwoven fabric, the process comprises: forming a first layer comprising hydrophilic spunbond fibers including a hydrophilic melt additive; forming a second layer comprising hydrophobic meltblown fibers disposed over the first layer; forming a third layer comprising hydrophobic spunbond fibers disposed over the second layer; and calendering the first, second, and third layers between two calender rolls.

In at least one embodiment, the hydrophilic melt additive is included at a percent addition of about 2.5 to 6%.

In at least one embodiment, the hydrophilic melt additive is included at a percent addition of about 4%.

In at least one embodiment, the hydrophilic spunbond fibers are comprised of at least one of polypropylene, polyethylene, polyester, polyamide, polylactic acid.

In at least one embodiment, the second and third layers are comprised of at least one of polypropylene, polyethylene, polyester, polyamide, and polylactic acid.

In at least one embodiment, the hydrophobic fibers of the second and third layers include a hydrophobic melt additive.

In at least one embodiment, the nonwoven has an absorptive capacity of at least 100%.

In at least one embodiment, the nonwoven fabric has an absorbent capacity of about 300 to 500%.

In at least one embodiment, the nonwoven fabric has a hydrostatic head of at least 30 mbar when challenged from the hydrophilic outer surface.

In at least one embodiment, wherein the nonwoven fabric has a hydrostatic head of at least 30 to 65 mbar when challenged from the hydrophobic outer surface.

In at least one embodiment, wherein the nonwoven fabric has an air permeability of at least about 30 cfm.

In at least one embodiment, wherein nonwoven fabric has a spunbond content of about 50 to 90% and meltblown content of about 10 to 50%.

In at least one embodiment, nonwoven fabric has a spunbond content of about 72 to 78% and a meltblown content of about 22 to 28%.

In at least one embodiment, the basis weight of the nonwoven fabric is between about 10 to 100 gsm.

In at least one embodiment, the basis weight of the nonwoven fabric is between about 34 to 68 gsm.

In at least one embodiment, the basis weight of the nonwoven fabric is between about 40 to 44 gsm.

In at least one embodiment, one of the calender rolls is an engraved calender roll contacting an outer surface first layer and the other of the calender rolls is a smooth calender roll contacting an outer surface of the third layer.

These and other features of this invention are described in, or are apparent from, the following detailed description of various exemplary embodiments of this invention.

### BRIEF DESCRIPTION OF THE DRAWINGS

Example embodiments of this invention will be described with reference to the accompanying figures.

FIG. 1 is a cross sectional view of a nonwoven fabric according to one embodiment of the present invention.

FIG. 2 is a schematic view of a process of manufacturing a nonwoven fabric according to one embodiment of the present invention.

### DETAILED DESCRIPTION OF THE EXAMPLE EMBODIMENTS

As used herein, “nonwoven fabric, sheet, layer or web” means a structure of individual fibers, filaments, or threads that are positioned in a substantially random manner to form a planar material, as opposed to a knitted or woven fabric. Examples of nonwoven fabrics include meltblown webs, spunbond webs, carded webs, air-laid webs, wet-laid webs, and spunlaced webs. A nonwoven composite fabric comprises more than one nonwoven layer.

As used herein, “spunbond fibers” means fibers that have an average cross section diameter of greater than 10 μm. Spunbond webs are formed by laying spunbond fibers randomly on a collecting surface, and subsequently bonding the fibers, such as by thermal bonding, hydroentanglement, or the like.

As used herein, “meltblown fibers” means fibers that have an average cross sectional diameter of less than about 10 μm. Meltblown webs are formed by laying meltblown fibers randomly on a collecting surface, and bonding, such as by thermal bonding, hydroentanglement, or the like.

As used herein, “spunbond fibers” and “meltblown fibers” are preferably substantially continuous fibers but are not limited thereto. For example, staple fibers or carded fibers may be used instead or in conjunction with substantially continuous fibers.

As used herein, an “SMS nonwoven fabric” refers to a multi-layer composite fabric comprising a layer of meltblown fibers bonded between two layers of spunbond fibers (e.g., a spunbond-meltblown-spunbond). The SMS nonwoven fabric can include multiple layers of spunbond or meltblown fibers, such as an SMMS (spunbond-meltblown-meltblown-spunbond), SMSS (spundbond-meltblown-spunbond-spunbond), or the like.

The present invention is a two-sided hydrophobic/hydrophilic nonwoven composite fabric, and a process of manufacturing thereof.

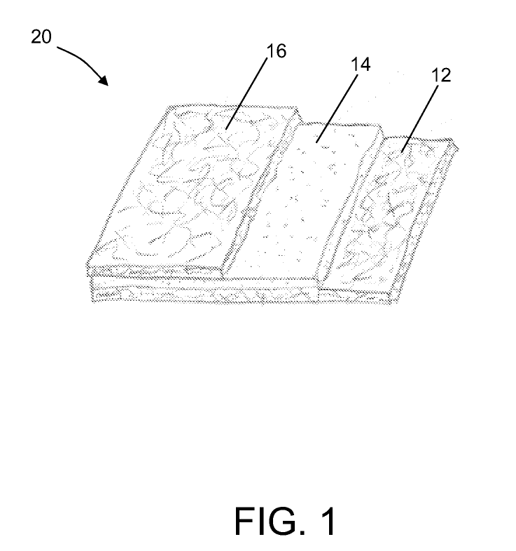

Referring to FIG. 1, according to one exemplary embodiment of the present invention, a nonwoven fabric 20 is formed in a composite SMS configuration, wherein at least one meltblown layer 14 is laminated between a first spunbond layer 12 and a second spunbond layer 16. One side of the nonwoven is hydrophilic and exhibits good wettability and absorption properties, while the opposite side is hydrophobic and non-wetting. The entire structure exhibits barrier properties when challenged at the hydrophobic side.

The fibers of the spunbond and meltblown layers may be comprised of a thermoplastic polymer, which may be one of various homopolymers, copolymers, and terpolymers. For example, the polymer may be polypropylene, polyethylene, polyester, polyamide, or the like. The polymer may also be a renewable material, such as polylactic acid (PLA). The fibers may be configured as single component fibers or multicomponent fibers consisting of two or more polymers, such as in a blend, a sheath/core configuration, a side-by-side configuration, or other known configuration.

In the case of a blend of two polymers, it is preferred that one of the components be the majority component and the other be the minority component. In such instances, numerous polymers may serve as the majority and minority components. It is preferred that the fibers of the spunbond layers are comprised of a blend in which the minority component is a polypropylene resin, such as ExxonMobil SFT-315, ExxonMobil SFT-325, ExxonMobil PP-3155, LyondellBasell PH 835, Total 3866, or the like, and the majority component is polypropylene copolymer resin, such as Moplen RP348S, Moplen RP349S, Sunoco TR3350C, Total 7847MR, or the like. It is preferred that the fibers of the meltblown layers are comprised of a polypropylene resin, such as ExxonMobil 6936G, ExxonMobil 3746G, LyondellBasell 650Y, or the like. Blends with more than two polymers may also be employed. The additional polymers may have an effect on the properties of the blend, for example, blend compatibility, viscosity, or the like.

The nonwoven fabric may have a basis weight of about 10-100 gsm, more preferably about 34-68 gsm, and still more preferably about 40-44 gsm. The nonwoven fabric may have a spunbond content of about 50-90% and meltblown content of about 10-50%, more preferably a spunbond content of about 72-78% and a meltblown content of about 22-28%.

A hydrophilic melt additive may be included in the fibers of one of the spunbond layers to increase wettability and absorption properties. The hydrophilic melt additive is non-migratory so that it is retained only in the hydrophilic spunbond layer of the fabric. For example, the hydrophilic melt additive may be a surface modifier, such as Techmer TPM12713 manufactured by Techmer PM, LLC, Irgasurf® HL 560 manufactured by Ciba®, or the like. The hydrophilic melt additive is preferably included at a percent addition of about 2.5 to 6%, and more preferably at about 3 to 4%.

A hydrophobic melt additive may be included in the fibers of the barrier layers, the meltblown layer and/or the opposite spunbond layer, to increase the repellency to fluid penetration through the nonwoven fabric. For example, the melt additive may be a fluoropolymer, such as, Goulston A202M and Goulston A202S, both manufactured by Goulston Technologies, Inc., which can be used for the meltblown layer and the opposite spunbond layer, respectively. The meltblown layer preferably includes the hydrophobic melt additive at a percent addition of about 5 to 10%, and more preferably at about 8 to 10%. The opposite spunbond layer preferably includes the hydrophobic melt additive at a percent addition of about 2 to 5%, and more preferably at about 3-4%.

A naturally hydrophobic material, for example, polypropylene, may be used as the basis for the fibers for any of the layers of the nonwoven. A slightly more hydroscopic material, for example, PLA, would be preferable for use in the hydrophilic spunbond layer rather than the hydrophobic barrier layers due to the affinity of hydroscopic materials for absorbing at least some water. However, a slightly more hydroscopic material may be used for the barrier layers if made hydrophobic, such as through the use of hydrophobic additives or treatments.

Other compatible additives that have a desired effect on the properties of the nonwoven fabric may be included in the fibers. For example, the fibers may include tackifiers, surfactants, plasticizers, stabilizers, anti-statics, alcohol-repellants, anti-microbials, colorants, and the like. Topical treatments may also be applied to the fibers of the nonwoven fabric to obtain the desired properties.

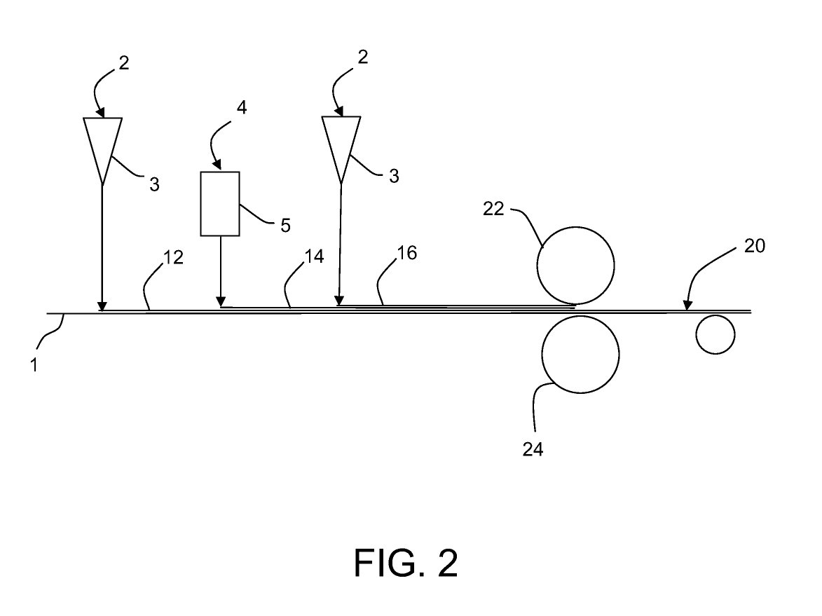

FIG. 2 illustrates a process of manufacturing a nonwoven fabric 20 according to an exemplary embodiments of the present invention.

In one embodiment, the SMS nonwoven fabric is be formed in-line by sequentially depositing a first layer of spunbond fibers 12 on a moving collecting surface 1, a layer of meltblown fibers 14 over the first layer of spunbond fibers 12, and then a second layer of spunbond fibers 16 over the layer of meltblown fibers 14. The assembled layers may be laminated together, such as by calendering.

In another embodiment, the individual spunbond and meltblown layers are pre-formed, optionally bonded or entangled, and collected as individual sheets, such as by winding the sheets on wind-up rolls. The individual sheets can be subsequently assembled by layering and then laminated together to form the SMS nonwoven fabric.

The spunbond layers 12 and 16 can be spun-melt, but may be formed by a variety of other processes known in the art. The spun-melting process comprises inserting a polymer material 2 into a spinneret 3. A hydrophilic or hydrophobic melt additive may be added to the polymer 2. The thermoplastic polymer material 2 is extruded through a plurality of fine capillaries in the spinneret 3 to form fibers. The diameter of the fibers are rapidly reduced by air quenching and drawing, and quasi-randomly deposited on a collecting surface 1 to form a spunbond web. Multiple spinnerets or beams may be used to provide an increased density of spunbond fibers.

The meltblown layer 14 can be formed by meltblowing. The meltblowing process comprises inserting a polymer material 4 into a die 5. A hydrophobic melt additive may be added into the polymer material 4. The polymer material is extruded through a plurality of fine capillaries in the die 5 to form fibers. The fibers stream into a high velocity gas (e.g. air) stream which attenuates the streams of molten thermoplastic polymer material to reduce their diameter, which may be to the microfiber diameter. The meltblown fibers are quasi-randomly deposited over the spunbond layer 12 to form a meltblown layer. Multiple dies or beams may be used to provide an increased density of meltblown fibers. If multiple beams are used, the average fiber diameter may be varied between beams, for example to create a gradient. The meltblown fibers can be tacky when they are deposited, which generally results in some bonding between the meltblown fibers of the web. Subsequently, the second spunbond layer 16 is deposited over the meltblown layer 14.

The layers 12, 14, 16 may be calendered by being passed through a calender nip between a heated smooth calender roll 22 and a heated patterned calender roll 24. The patterned calender roll 22 forms a bond pattern including a plurality of bonding points 120. The bonding points 120 give web strength to the nonwoven, as well as providing adhesion between the layers to prevent delamination.

The bond pattern may, for example, be a non-symmetrical pattern of fusion bonds. Commonly owned U.S. Pat. Nos. 6,537,644, 6,610,390, and 6,872,274, each of which is incorporated herein by reference, disclose nonwoven fabrics having a non-symmetrical pattern of fusion bonds (that is, an anisotropic or asymmetrical pattern). The bonds may be simple fusion bonds or closed figures elongated in one direction. The bonds may be closed figures elongated in one direction and selected from the group consisting of closed figures (a) oriented in parallel along the one direction axis, (b) oriented transverse to adjacent closed figures along the one direction axis, and (c) oriented sets with proximate closed figures so as to form there between a closed configuration elongated along the one direction axis. The PILLOW BOND® pattern available from First Quality Nonwovens, Inc. is an example of one such non-symmetrical pattern of fusion bonds.

After bonding, the nonwoven fabric 20 may be treated with a finish at a finishing station to render it softer and more condrapable, such a finish being disclosed in U.S. Pat. No. 6,632,385, which is hereby incorporated by reference, or to modify the surface energy thereof and thereby render it either more hydrophobic or more hydrophilic.

The nonwoven fabric of the present invention may find utility in a wide variety of industrial, medical, and hygiene applications. For example, the nonwoven fabric may be useful in medical and industrial protective clothing, scrub suits, surgical gowns, surgical drapes, facemasks and the like, in which the hydrophilic side placed toward the body of the user provides improved perspiration and fluid wicking, while the hydrophobic side maintains a repellent barrier on the outside away from the user. The nonwoven fabric may also find similar utility in absorbent articles, such as in backsheets and leg cuffs.

The nonwoven fabric further may be useful as cleaning wipes and substrates in which the hydrophilic side absorbs a spilled liquid or contains a cleaning solution, while the hydrophobic side is kept dry to the touch.

Other industrial applications for the nonwoven fabric may include central supply room (CSR) wrapping, packaging, furniture and bedding, shoe components and the like.

The specification of particular applications hereinabove is to be taken as exemplary only, and not to be limiting or to be inclusive of all the potential applications. Uses other than the aforementioned industrial, hygiene and medical applications follow naturally from the physical and chemical properties of the materials of the present invention.

### Examples

In the examples that follow, the following test methods were employed to determine various reported characteristics and properties.

Basis weight is a measure of the mass per unit area of the fabric. Basis weight and was measured by ASTM D-6242-98, which is hereby incorporated by reference, and is reported in g/m² (gsm).

Air permeability is a measure of air flow passing through a fabric under a stated pressure differential between the surfaces of the fabric. Air permeability was measured according to ASTM D753, which is hereby incorporated by reference, and is reported in ft³/min (cfm).

Hydrostatic head is a measure of the pressure of a liquid that the fabric can support when challenged from the hydrophobic side. Hydrostatic head was determined according to INDA 80.6-98, which is hereby incorporated by reference, and is reported in mbar.

Grab tensile strength is a measure of the maximum force needed to break a material. Grab tensile strength was calculated in the cross direction (CD) and determined according to ASTM 5034, which is hereby incorporated by reference, and is reported in lbf.

Trapezoidal tear strength is a measure of the ability to resist a continued tear across the fabric. Trapezoidal tear strength was calculated in the machine direction (MD) and determined according to ASTM 5733, which is hereby incorporated by reference, and is reported in lbf.

Electrostatic decay is a measure of the electrostatic properties of a material by measuring the time required for dissipating a charge from the surface of the material. Electrostatic decay was measured according to INDA WSP 40.2, which is hereby incorporated by reference, as in reported in seconds.

Absorptive capacity is a measure of the capacity of a material to absorb liquid over a period of time and is related to the total amount of liquid held by a material at its point of saturation. The absorptive capacity is calculated as the weight of liquid absorbed divided by the weight of the dry sample. Absorptive capacity is determined according to EDANA ERT 10.4-02, which is hereby incorporated by reference, and is reported as a percentage.

Used as a control was a conventional 44.1 gsm basis weight polypropylene SMS nonwoven fabric, available from First Quality Nonwovens, Inc. under the trade name of 441SM0001. Also tested as a control was a 44.1 gsm basis weight polypropylene SMS nonwoven, available from First Quality Nonwovens, Inc. under the trade name of KAZZMERE™.

The examples of the SMS nonwoven fabric prepared according to the present invention were formed in a similar manner as the Kazzmere™ nonwoven, but which included in the hydrophilic spunbond layer a percent addition of 4% of a hydrophilic melt additive, available from Techmer PM, LLC under the trade name of Techmer TPM12713. The samples of Example 2 differed from Example 1 in that the colorant was removed from the hydrophilic spunbond layer. The nonwoven fabric in the examples had a basis weight of 44.1 gsm.

The averaged results are illustrated in the Table I below:

TABLE 1
Comparative Properties of Example SMS Nonwoven Fabric

| | | | Hydrostatic | CD Grab | MD | CD Electrostatic | Absorptive |
|---|---|---|---|---|---|---|---|
| | Basis Weight | Air Perm. | Head | Tensile | Trapezoidal | Decay, 50% RH | capacity |
| Example No. | (gsm) | (cfm) | (mbar) | (lb) | Tear (lb) | (sec.) | (%) |
| SMS | 44.1 | 50 | 75 | 18.0 | 8.0 | No charge | 21.2 |
| 441SM0001 | | | | | | | |
| SMS | 44.1 | 55 | 70 | 18.0 | 8.0 | No charge | 12.8 |
| Kazzmere ™ | | | | | | | |
| Example 1 | 44.1 | 60 | 60 | 18.0 | 8.0 | — | 350 |
| Example 2 | 45.3 | 57 | 65 | 15.6 | 8.0 | 0.6 | 465 |

The data of TABLE 1 shows that the SMS nonwoven fabric according to the present invention provided a significant improvement in absorptive capacity as compared to the conventional SMS nonwoven fabrics, while retaining similar air permeability and hydrostatic head properties. The SMS nonwoven fabric according to the present invention also surprisingly exhibited electrostatic decay properties. Further, the SMS nonwoven fabric according to the present invention exhibited similar tensile strength, and tear strength as compared to the conventional SMS nonwoven fabrics.

For barrier protection, a hydrostatic head of at least 50 mbar (AAMI3) is typically considered acceptable for a disposable barrier garment such as a surgical gown, surgical drape, or the like. Special applications may require a higher head or permit a lower head. For wearing comfort, an air permeability prior to liquid insult of at about 20-150 cfm is typically considered acceptable for a disposable barrier product, such as a surgical gown, drape, etc. Each of the various embodiments of the SMS nonwoven fabric according to the present invention is capable of meeting both of these wearing comfort and barrier protection criteria.

It was observed that in the absorbency test of the conventional SMS nonwoven fabrics, water droplets remained on the surface of the fabric rather than being absorbed into the fibers, which contributed to the absorbency values listed. In contrast, the SMS nonwoven fabric of the present invention was fully wetted out on the hydrophilic side, while still retaining barrier properties on the hydrophilic side.

To summarize, the present invention provides a nonwoven fabric which affords increased absorptive properties and comfort, but which also delivers high levels of barrier protection. The nonwoven fabric achieves this by demonstrating hydrophilic properties on one side, while retaining hydrophobic properties at the opposing side. The hydrophilicity is imparted by a hydrophilic additive which is durable so that the hydrophilicity does not diminish with increased wettings, and which is non-migratory to retain the hydrophobicity of the other parts of the structure of the nonwoven fabric.

Now that embodiments of the present invention have been shown and described in detail, various modifications and improvements thereon will become readily apparent to those skilled in the art. Accordingly, the spirit and scope of the present invention is to be construed broadly and limited only by the appended claims, and not by the foregoing specification.

What is claimed is:

1. A nonwoven fabric comprising:
a first layer comprising hydrophilic spunbond fibers including a hydrophilic melt additive, the first layer forming at least one exposed outer surface of the nonwoven fabric;
a second layer comprising hydrophobic spunbond fibers, the second layer forming an opposite exposed outer surface of the nonwoven fabric; and
a third layer comprising meltblown fibers interposed between the first and second layers;
wherein the nonwoven fabric has an absorptive capacity of at least 100%.

2. The nonwoven fabric of claim 1, wherein the nonwoven fabric has an absorbent capacity of about 300 to 500%.

3. The nonwoven fabric of claim 1, wherein the nonwoven fabric has a hydrostatic head of at least 30 mbar when challenged from the hydrophilic outer surface.

4. The nonwoven fabric of claim 3, wherein the nonwoven fabric has a hydrostatic head of at least 30 to 65 mbar when challenged from the hydrophobic outer surface.

5. The nonwoven fabric of claim 1, wherein the nonwoven fabric has an air permeability of at least about 30 cfm.

6. The nonwoven fabric of claim 1, wherein nonwoven fabric has a spunbond content of about 50 to 90% and meltblown content of about 10 to 50%.

7. The nonwoven fabric of claim 6, wherein nonwoven fabric has a spunbond content of about 72 to 78% and a meltblown content of about 22 to 28%.

8. The nonwoven fabric of claim 1, wherein the hydrophilic melt additive is included at a percent addition of about 2.5 to 6%.

9. The nonwoven fabric of claim 8, wherein the hydrophilic melt additive is included at a percent addition of about 3 to 4%.

10. The nonwoven fabric of claim 1, wherein the hydrophilic melt additive is non-migratory to the other layers of the fabric.

11. The nonwoven fabric of claim 1, wherein the hydrophilic spunbond fibers are comprised of a at least one of polypropylene, polyethylene, polyester, polyamide, and polylactic acid.

12. The nonwoven fabric of claim 1, wherein the of the second and third layers are comprised of at least one of polypropylene, polyethylene, polyester, polyamide, and polylactic acid.

13. The nonwoven fabric of claim 1, wherein the basis weight of the nonwoven fabric is between about 10 to 100 gsm.

14. The nonwoven fabric of claim 13, wherein the basis weight of the nonwoven fabric is between about 34 to 68 gsm.

15. The nonwoven fabric of claim 14, wherein the basis weight of the nonwoven fabric is between about 40 to 44 gsm.

16. An absorbent article comprising the nonwoven fabric of claim 1.

17. Medical protective apparel comprising the nonwoven fabric of claim 1.

18. A process of manufacturing a nonwoven fabric, the process comprising:
forming a first layer comprising hydrophilic spunbond fibers including a hydrophilic melt additive;
forming a second layer comprising hydrophobic meltblown fibers disposed over the first layer;
forming a third layer comprising hydrophobic spunbond fibers disposed over the second layer; and
calendering the first, second, and third layers between two calender rolls.

19. The process of claim 18, wherein the hydrophilic melt additive is included at a percent addition of about 2.5 to 6%.

20. The process of claim 19, wherein the hydrophilic melt additive is included at a percent addition of about 3 to 4%.

21. The process of claim 18, wherein the hydrophilic spunbond fibers are comprised of a at least one of polypropylene, polyethylene, polyester, polyamide, and polylactic acid.

22. The process of claim 18, wherein the second and third layers are comprised of at least one of polypropylene, polyethylene, polyester, polyamide, and polylactic acid.

23. The process of claim 18, wherein the hydrophobic fibers of the second and third layers include a hydrophobic melt additive.

23. The process of claim 18, wherein the nonwoven has an absorptive capacity of at least 100%.

24. The process of claim 24, wherein the nonwoven fabric has an absorbent capacity of about 300 to 500%.

25. The process of claim 18, wherein the nonwoven fabric has a hydrostatic head of at least 30 mbar when challenged from the hydrophilic outer surface.

26. The process of claim 26, wherein the nonwoven fabric has a hydrostatic head of at least 30 to 65 mbar when challenged from the hydrophilic outer surface.

27. The process of claim 18, wherein the nonwoven fabric has an air permeability of at least about 30 cfm.

28. The process of claim 18, wherein nonwoven fabric has a spunbond content of about 50 to 90% and meltblown content of about 10 to 50%.

29. The process of claim 29, wherein nonwoven fabric has a spunbond content of about 72 to 78% and a meltblown content of about 22 to 28%.

30. The process of claim 18, wherein the basis weight of the nonwoven fabric is between about 10 to 100 gsm.

31. The process of claim 31, wherein the basis weight of the nonwoven fabric is between about 34 to 68 gsm.

32. The process of claim 31, wherein the basis weight of the nonwoven fabric is between about 40 to 44 gsm.

33. The process of claim 18, wherein one of the calender rolls is an engraved calender roll contacting an outer surface first layer and the other of the calender rolls is a smooth calender roll contacting an outer surface of the third layer.
